(19) United States
(12) Patent Application Publication
(10) Pub. No.: US 2017/0261816 A1
(43) Pub. Date: Sep. 14, 2017

(54) LIQUID CRYSTAL DISPLAY PANEL AND MANUFACTURE METHOD THEREOF

(71) Applicant: Shenzhen China Star Optoelectronics Technology Co. Ltd., Shenzhen, Guangdong (CN)

(72) Inventors: Yongchao ZHAO, Shenzhen, Guangdong (CN); Chung-ching HSIEH, Shenzhen, Guangdong (CN); Xiang LI, Shenzhen, Guangdong (CN)

(73) Assignee: Shenzhen China Star Optoelectronics Technology Co., Ltd., Shenzhen, Guangdong (CN)

(21) Appl. No.: 15/023,399

(22) PCT Filed: Dec. 31, 2015
(86) PCT No.: PCT/CN2015/100356

§ 371 Date: Mar. 20, 2016

(30) Foreign Application Priority Data
Oct. 13, 2015 (CN) 201510658806.4

(51) Int. Cl. G02F 1/1337; G02F 1/1335; G02F 1/1341; G02F 1/1368

(52) U.S. Cl. CPC G02F 1/133753; G02F 1/133788; G02F 1/1368; G02F 1/133514; G02F 1/1341; G02F 2001/133761

(57) ABSTRACT

The present disclosure discloses a liquid crystal display panel and a manufacture method thereof, including: radiating substrates with the ultraviolet light to make alignment films on the substrates to form a pre-tilt angle; injecting liquid crystal molecules containing reactive monomers in between two substrates, a pre-tilt angle of the liquid crystal molecules under the influence of the alignment films after matching is a first angle value; radiating substrates with the ultraviolet light and applying electric field between the two substrates to radiate the reactive monomers with the ultraviolet light, a pre-tilt angle of the liquid crystal molecules is a second angle value.

### FIELD OF THE DISCLOSURE

The present disclosure relates to a liquid crystal display technology field, and more particularly to a liquid crystal display panel and a manufacture method thereof.

### BACKGROUND OF THE DISCLOSURE

The UV2A light alignment technology is one of the most advanced vertical alignment techniques of a liquid crystal display panel currently, but the optical property and stability are not good enough. In the preparation of optical alignment materials, ingredients and contents can be adjusted to ensure the stability of a pre-tilt angle of liquid crystal molecules, but it can cause a problem that the pre-tilt angle is difficult to be formed or only a small pre-tilt angle is formed. A small pre-tilt angle can affect the optical property, such as the response is delayed.

Therefore, a liquid crystal display panel and a manufacture method thereof are necessary to be provided to solve the problem above.

### SUMMARY OF THE DISCLOSURE

The technical issue that the embodiment of the present disclosure solves is to provide a liquid crystal display panel, which can increase the value of a pre-tilt angle of liquid crystal molecules without altering materials of alignment films.

A proposal provided by the present disclosure to solve the problem above is: providing a manufacture method of a liquid crystal display panel, the manufacture method includes: providing a first substrate and a second substrate; forming alignment films on the first substrate or the second substrate; radiating the first substrate or the second substrate with the alignment films formed obliquely by a polarized ultraviolet light, in order to make the alignment films to form an alignment pre-tilt angle; matching the first substrate and the second substrate as a group and injecting liquid crystal molecules containing reactive monomers in between the first substrate and the second substrate to form a liquid crystal layer, a plurality of regions of liquid crystal molecules with different tilting directions are formed in the liquid crystal layer under the influence of the alignment films after group matching, the pre-tilt angle of the liquid crystal molecules is a first angle value; radiating the first substrate or the second substrate vertically by a non-polarized ultraviolet light in a first period of time, and applying electric field between the first substrate and the second substrate, in order to rotate the liquid crystal molecules by radiating the non-polarized ultraviolet light on the reactive monomers, a value of the second angle controlled by various first periods of time is a second angle value, the second angle value is larger than the first angle value.

Forming the alignment films on the first substrate or the second substrate is: forming a first alignment film on the first substrate, forming a second alignment film on the second substrate; radiating the first substrate or the second substrate with the alignment films formed obliquely by the polarized ultraviolet light, in order to make the alignment films to form an alignment pre-tilt angle is: radiating the first substrate with a first alignment film formed obliquely by the polarized ultraviolet light, in order to make the first alignment film to form a first alignment pre-tilt angle, radiating the second substrate with a second alignment film formed obliquely by the polarized ultraviolet light, in order to make the second alignment film to form a second alignment pre-tilt angle; matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is: matching the first substrate and the second substrate as a group and injecting liquid crystal molecules containing reactive monomers in between the first substrate and the second substrate to form a liquid crystal layer, under the influence of the first alignment film and the second alignment film after group matching, the pre-tilt angle of the liquid crystal molecules being a first angle value.

Providing a first substrate and a second substrate is: providing a thin film transistor array substrate and a color filter plate substrate.

To solve the problem above, another proposal provided by the disclosure is: providing a manufacture method of a liquid crystal display panel, the manufacture method includes: providing a first substrate and a second substrate; forming alignment films on the first substrate or the second substrate; radiating the first substrate or the second substrate with the alignment films formed obliquely by a polarized ultraviolet light, in order to make the alignment films to form an alignment pre-tilt angle; matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules is a first angle value; radiating the first substrate or the second substrate vertically by a non-polarized ultraviolet light, and applying electric field between the first substrate and the second substrate, in order to rotate the liquid crystal molecules by radiating the non-polarized ultraviolet light on the reactive monomers, a value of the pre-tilt angle of the liquid crystal molecules is a second angle value, the second angle value is larger than the first angle value.

Matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is: matching the first substrate and the second substrate as a group and injecting liquid crystal molecules containing reactive monomers in between the first substrate and the second substrate to form a liquid crystal layer, a plurality of regions of liquid crystal molecules with different tilting directions formed in the liquid crystal layer under the influence of the alignment films after group matching, the pre-tilt angle of the liquid crystal molecules being a first angle value.

Radiating the first substrate or the second substrate vertically by a non-polarized ultraviolet light, and applying electric field between the first substrate and the second substrate, in order to rotate the liquid crystal molecules by radiating the non-polarized ultraviolet light on the reactive monomers, a value of the pre-tilt angle of the liquid crystal molecules being a second angle value, the second angle value larger than the first angle value is: radiating the first substrate or the second substrate vertically by a non-polarized ultraviolet light in a first period of time, and applying electric field between the first substrate and the second substrate, in order to rotate the liquid crystal molecules by radiating the non-polarized ultraviolet light on the reactive monomers, a value of the second angle controlled by various first period of time being a second angle value, the second angle value is larger than the first angle value.

Forming alignment films on the first substrate or the second substrate is: forming a first alignment film on the first substrate, forming a second alignment film on the second substrate; radiating the first substrate or the second substrate with the alignment films formed obliquely by the polarized ultraviolet light, in order to make the alignment films to form an alignment pre-tilt angle is: radiating the first substrate with a first alignment film formed obliquely by the polarized ultraviolet light, in order to make the first alignment film to form a first alignment pre-tilt angle, radiating the second substrate with a second alignment film formed obliquely by the polarized ultraviolet light, in order to make the second alignment film to form a second alignment pre-tilt angle; matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is: matching the first substrate and the second substrate as a group and injecting liquid crystal molecules containing reactive monomers in between the first substrate and the second substrate to form a liquid crystal layer, under the influence of the first alignment film and the second alignment film after group matching, the pre-tilt angle of the liquid crystal molecules being a first angle value.

Providing a first substrate and a second substrate is: providing a thin film transistor array substrate and a color filter plate substrate.

To solve the problem above, another proposal provided by the disclosure is: providing a liquid crystal display panel, the liquid crystal display panel includes a first substrate and a second substrate disposed opposite, a liquid crystal layer containing liquid crystal molecules between the first substrate and the second substrate, at least one layer of alignment film disposed on the first substrate or the second substrate, the liquid crystal molecules includes reactive monomers, the liquid crystal molecules have a pre-tilt angle, and the pre-tilt angle of the liquid crystal molecules is formed by radiating the alignment films on the first substrate or the second substrate obliquely by a polarized ultraviolet light, a first angle value is formed by matching the first substrate and the second substrate under the influence of the alignment films, subsequently radiating the first substrate or the second substrate vertically by a non-polarized ultraviolet light, and applying electric field between the first substrate and the second substrate to rotate the liquid crystal molecules by radiating the non-polarized ultraviolet light on the reactive monomers, a pre-tilt angle with a second angle value is formed, the second angle value is larger than the first angle value.

When radiating the alignment films on the first substrate or the second substrate obliquely by a polarized ultraviolet light, a first angle value is formed by matching the first substrate and the second substrate under the influence of the alignment films, a plurality of regions of liquid crystal molecules with different tilting directions are formed in the liquid crystal layer under the influence of the alignment films.

Radiating the first substrate or the second substrate vertically by a non-polarized ultraviolet light in a first period of time, and applying electric field between the first substrate and the second substrate to rotate the liquid crystal molecules by radiating the non-polarized ultraviolet light on the reactive monomers, a pre-tilt angle with a second angle value is formed, the second angle value is controlled by various first periods of time.

A first alignment film is disposed on the first substrate, a second alignment film is disposed on the second substrate, the polarized ultraviolet light radiates obliquely the first substrate and the second substrate respectively and affects the first alignment film and the second alignment film, making the first alignment to form a first alignment pre-tilt angle and the second alignment to form a second alignment pre-tilt angle.

The reactive monomers are RM materials.

Benefits of the disclosure: distinguishing from a conventional technique, according to the disclosure, an alignment pre-tilt is formed on an alignment film by a polarized ultraviolet light radiated on a first substrate or a second substrate obliquely, liquid crystal molecules generate a pre-tilt angle with a first angle value when the first substrate and the second substrate match under the influence of alignment films, then radiating the first substrate or the second substrate by a non-polarized ultraviolet light vertically, the non-polarized ultraviolet light radiated on reactive monomers in liquid crystal molecules to rotate the liquid crystal molecules to form a pre-tilt angle with a second angle value, hence the disclosure can increase the value of the pre-tilt angle of liquid crystal molecules without altering the material of alignment films.

### BRIEF DESCRIPTION OF THE DRAWINGS

FIG. 1 is a flow chart of a manufacture method of a liquid crystal display panel according to the present disclosure;

FIG. 2 is an ingredient diagram of an alignment film according to the disclosure;

FIG. 3 is a diagram of a matched liquid crystal display panel according to the disclosure;

FIG. 4 is a diagram of a single board of a first substrate and a second substrate before matching according to the disclosure.

### DETAILED DESCRIPTION OF PREFERRED EMBODIMENTS

Embodiments of the present disclosure are described in detail with reference to the accompanying drawings as follows.

Referring to FIG. 1, FIG. 1 is a flow chart of a manufacture method of a liquid crystal display panel according to the present disclosure. In the embodiment, a manufacture method of a liquid crystal display panel includes:

Step S11: providing a first substrate and a second substrate.

Step S11: providing a first substrate and a second substrate is: providing a thin film transistor array substrate and a color filter plate substrate. The first substrate is the thin film transistor array substrate, the second substrate is the color filter plate substrate; or the second substrate is the thin film transistor array substrate, the first substrate is the color filter plate substrate.

Step S12: forming alignment films on the first substrate or the second substrate.

In step S12, forming the alignment films on the first substrate or the second substrate is: forming a first alignment film on the first substrate, forming a second alignment film on the second substrate. In other embodiments, forming the alignment films on the first substrate or the second substrate can also be: forming an alignment film merely on the first substrate or merely on the second substrate.

Step S13: radiating the first substrate or the second substrate with the alignment films formed obliquely by the polarized ultraviolet light, in order to make the alignment films to form an alignment pre-tilt angle.

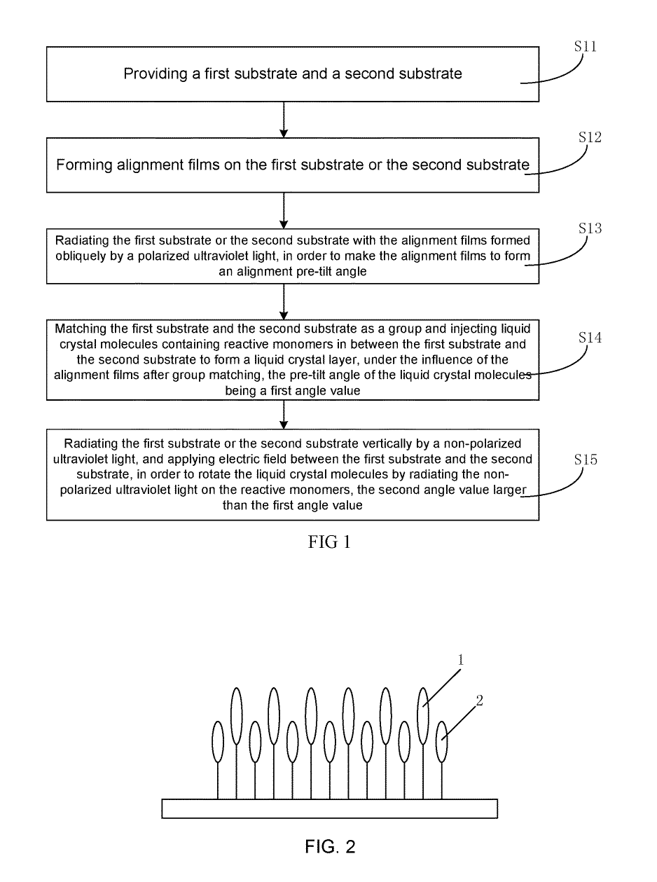

In step S13, radiating the first substrate or the second substrate with the alignment films formed obliquely by the polarized ultraviolet light, in order to make the alignment films to form an alignment pre-tilt angle is: radiating the first substrate with a first alignment film formed obliquely by the polarized ultraviolet light, in order to make the first alignment film to form a first alignment pre-tilt angle, radiating the second substrate with a second alignment film formed obliquely by the polarized ultraviolet light, in order to make the second alignment film to form a second alignment pre-tilt angle. Referring to FIG. 2, FIG. 2 is an ingredient diagram of an alignment film according to the disclosure. The alignment films mainly consist of two sorts of functional ingredients, a first ingredient 1 is an ingredient to keep the pre-tilt angle stable, which guarantee the pre-tilt angle stays constantly during long-term utilization, a second ingredient 2 is an optical response ingredient 2, mainly for forming an alignment pre-tilt angle. Radiating the first substrate or the second substrate with the alignment films formed obliquely by the polarized ultraviolet light, in order to make the alignment films to form an alignment pre-tilt angle is: radiating the first substrate with a first alignment film formed obliquely by the polarized ultraviolet light, in order to make the first alignment film to form a first alignment pre-tilt angle, radiating the second substrate with a second alignment film formed obliquely by the polarized ultraviolet light, in order to make the second alignment film to form a second alignment pre-tilt angle.

Step S14: matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value.

In step S14, matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is: matching the first substrate and the second substrate as a group and injecting liquid crystal molecules containing reactive monomers in between the first substrate and the second substrate to form a liquid crystal layer, under the influence of the first alignment film and the second alignment film after group matching, the pre-tilt angle of the liquid crystal molecules being a first angle value. More specific, the pre-tilt angle of the liquid crystal molecules under the influence of the optical response ingredient 2 in the first alignment film and the second alignment film after group matching is the first angle value. Matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is: matching the first substrate and the second substrate as a group and injecting liquid crystal molecules containing reactive monomers in between the first substrate and the second substrate to form a liquid crystal layer, a plurality of regions of liquid crystal molecules with different tilting directions formed in the liquid crystal layer under the influence of the alignment films after group matching, the pre-tilt angle of the liquid crystal molecules being a first angle value.

Step S15, radiating the first substrate or the second substrate vertically by a non-polarized ultraviolet light, and applying electric field between the first substrate and the second substrate, in order to rotate the liquid crystal molecules by radiating the non-polarized ultraviolet light on the reactive monomers, a value of the pre-tilt angle of the liquid crystal molecules being a second angle value, the second angle value larger than the first angle value.

In Step S15, radiating the first substrate or the second substrate vertically by a non-polarized ultraviolet light, and applying electric field between the first substrate and the second substrate, in order to rotate the liquid crystal molecules by radiating the non-polarized ultraviolet light on the reactive monomers, a value of the pre-tilt angle of the liquid crystal molecules being a second angle value, the second angle value larger than the first angle value is: radiating the first substrate or the second substrate vertically by a non-polarized ultraviolet light in a first period of time, and applying electric field between the first substrate and the second substrate, in order to rotate the liquid crystal molecules by radiating the non-polarized ultraviolet light on the reactive monomers, a value of the second angle controlled by various first period of time being a second angle value, the second angle value is larger than the first angle value. Preferably, the second angle value increases along with the first period of time extends, the second angle decreases along with the first period of time reduces.

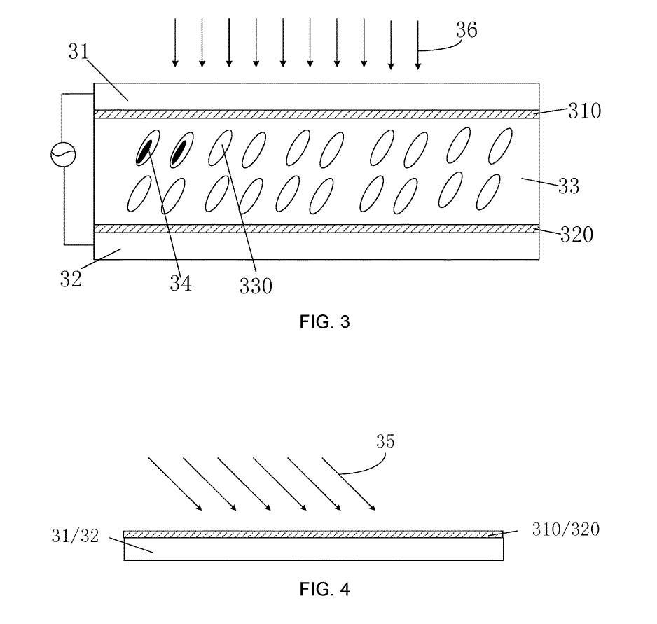

Referring to FIG. 3 and FIG. 4, FIG. 3 is a diagram of a matched liquid crystal display panel according to the disclosure, FIG. 4 is a diagram of a first substrate and a second substrate single board before matching according to the disclosure. In the embodiment, the liquid crystal display panel includes a first substrate 31 and a second substrate 32 disposed opposite, a liquid crystal layer 33 containing liquid crystal molecules 330 between the first substrate 31 and the second substrate 32, at least one layer of alignment film 310, 320 disposed on the first substrate 31 or the second substrate 32, the liquid crystal molecules 330 includes reactive monomers 34.

The liquid crystal molecules 330 have a pre-tilt angle, and the pre-tilt angle of the liquid crystal molecules 330 is formed by radiating the alignment films 310, 320 on the first substrate 31 or the second substrate 32 obliquely by a polarized ultraviolet light 35, a first angle value is formed by matching the first substrate 31 and the second substrate 32 under the influence of the alignment films 310, 320, subsequently radiating the first substrate 31 or the second substrate 32 vertically by a non-polarized ultraviolet light, and applying electric field between the first substrate 31 and the second substrate 32 to rotate the liquid crystal molecules 330 by radiating the non-polarized ultraviolet light on the reactive monomers 34, a pre-tilt angle with a second angle value is formed, the second angle value is larger than the first angle value.

Preferably, When radiating the alignment films on the first substrate or the second substrate obliquely by a polarized ultraviolet light, a first angle value is formed by matching the first substrate and the second substrate under the influence of the alignment films, a plurality of regions of liquid crystal molecules with different tilting directions are formed in the liquid crystal layer under the influence of the alignment films. To be noticed, the reactive monomers 34 are merely shown in partial liquid crystal molecules 330 in FIG. 3, which cannot represent little reactive monomers can be in other sections of the liquid crystal molecules 330, for convenience, not all the reactive monomers in the liquid crystal molecules 330 are labelled. And directions of the liquid crystal molecules 330 in the figure do not represent the real directions, the figure is only a possibility, equally in other figures.

Preferably, radiating the first substrate 31 or the second substrate 32 vertically by a non-polarized ultraviolet light 36 in a first period of time, and applying electric field between the first substrate 31 and the second substrate 32 to rotate the liquid crystal molecules 330 by radiating the non-polarized ultraviolet light on the reactive monomers 34, a pre-tilt angle with a second angle value is formed, the second angle value is controlled by various first periods of time. Preferably, the second angle value increases along with the first period of time extends, the second angle decreases along with the first period of time reduces.

Preferably, a first alignment film 310 is disposed on the first substrate 31, a second alignment film 320 is disposed on the second substrate 32, the polarized ultraviolet light 35 radiates obliquely the first substrate 31 and the second substrate 32 respectively and affects the first alignment film 310 and the second alignment film 320, making the first alignment 310 to form a first alignment pre-tilt angle and the second alignment 320 to form a second alignment pre-tilt angle. The liquid crystal molecules 330 form a pre-tilt angle with a first angle value under the influence of the first alignment film 310 and the second alignment film 320 during matching, a plurality of regions of liquid crystal molecules 330 with different tilting directions formed in the liquid crystal layer 33 under the influence of the first alignment film 310 and the second alignment 320.

Preferably, the reactive monomers are reactive mesogens (RM) materials, which means the RM materials are thermotropic liquid crystalline materials.

Referring to FIG. 2 again, the first alignment film 310 and the second alignment film 320 mainly consist of two sorts of functional ingredients, a first ingredient 1 is an ingredient to keep the pre-tilt angle stable, which guarantee the pre-tilt angle stays constantly during long-term utilization, a second ingredient 2 is an optical response ingredient 2, mainly for forming an alignment pre-tilt angle.

According to the disclosure, an alignment pre-tilt is formed on an alignment film by a polarized ultraviolet light radiated on a first substrate or a second substrate obliquely, liquid crystal molecules generate a pre-tilt angle with a first angle value when the first substrate and the second substrate match under the influence of alignment films, then radiating the first substrate or the second substrate by a non-polarized ultraviolet light vertically, the non-polarized ultraviolet light radiated on reactive monomers in liquid crystal molecules to rotate the liquid crystal molecules to form a pre-tilt angle with a second angle value, hence the disclosure can increase the value of the pre-tilt angle of liquid crystal molecules without altering the material of alignment films.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A manufacture method of a liquid crystal display panel, wherein the manufacture method comprises:
providing a first substrate and a second substrate;
forming alignment films on the first substrate or the second substrate;
radiating the first substrate or the second substrate with the alignment films formed obliquely by a polarized ultraviolet light, in order to make the alignment films to form an alignment pre-tilt angle;
matching the first substrate and the second substrate as a group and injecting liquid crystal molecules containing reactive monomers in between the first substrate and the second substrate to form a liquid crystal layer, a plurality of regions of liquid crystal molecules with different tilting directions formed in the liquid crystal layer under the influence of the alignment films after group matching, the pre-tilt angle of the liquid crystal molecules being a first angle value;
radiating the first substrate or the second substrate vertically by a non-polarized ultraviolet light in a first period of time, and applying electric field between the first substrate and the second substrate, in order to rotate the liquid crystal molecules by radiating the non-polarized ultraviolet light on the reactive monomers, a value of the second angle controlled by various first periods of time being a second angle value, the second angle value larger than the first angle value.

2. The manufacture method according to claim 1, wherein forming the alignment films on the first substrate or the second substrate is:
forming a first alignment film on the first substrate, forming a second alignment film on the second substrate;
radiating the first substrate or the second substrate with the alignment films formed obliquely by the polarized ultraviolet light, in order to make the alignment films to form an alignment pre-tilt angle is:
radiating the first substrate with a first alignment film formed obliquely by the polarized ultraviolet light, in order to make the first alignment film to form a first alignment pre-tilt angle, radiating the second substrate with a second alignment film formed obliquely by the polarized ultraviolet light, in order to make the second alignment film to form a second alignment pre-tilt angle;
matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is:
matching the first substrate and the second substrate as a group and injecting liquid crystal molecules containing reactive monomers in between the first substrate and the second substrate to form a liquid crystal layer, under the influence of the first alignment film and the second alignment film after group matching, the pre-tilt angle of the liquid crystal molecules being a first angle value.

3. The manufacture method according to claim 1, wherein providing a first substrate and a second substrate is:
providing a thin film transistor array substrate and a color filter plate substrate.

4. A manufacture method of a liquid crystal display panel, wherein the manufacture method comprises:
providing a first substrate and a second substrate;
forming alignment films on the first substrate or the second substrate;
radiating the first substrate or the second substrate with the alignment films formed obliquely by a polarized ultraviolet light, in order to make the alignment films to form an alignment pre-tilt angle;
matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value;
radiating the first substrate or the second substrate vertically by a non-polarized ultraviolet light, and applying electric field between the first substrate and the second substrate, in order to rotate the liquid crystal molecules by radiating the non-polarized ultraviolet light on the reactive monomers, a value of the pre-tilt angle of the liquid crystal molecules being a second angle value, the second angle value larger than the first angle value.

5. The manufacture method according to claim 4, wherein matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is:
matching the first substrate and the second substrate as a group and injecting liquid crystal molecules containing reactive monomers in between the first substrate and the second substrate to form a liquid crystal layer, a plurality of regions of liquid crystal molecules with different tilting directions formed in the liquid crystal layer under the influence of the alignment films after group matching, the pre-tilt angle of the liquid crystal molecules being a first angle value.

6. A manufacture method according to claim 4, wherein radiating the first substrate or the second substrate vertically by a non-polarized ultraviolet light, and applying electric field between the first substrate and the second substrate, in order to rotate the liquid crystal molecules by radiating the non-polarized ultraviolet light on the reactive monomers, a value of the pre-tilt angle of the liquid crystal molecules being a second angle value, the second angle value larger than the first angle value is:
radiating the first substrate or the second substrate vertically by a non-polarized ultraviolet light in a first period of time, and applying electric field between the first substrate and the second substrate, in order to rotate the liquid crystal molecules by radiating the non-polarized ultraviolet light on the reactive monomers, a value of the second angle controlled by various first period of time being a second angle value, the second angle value larger than the first angle value.

7. The manufacture method according to claim 4, wherein forming alignment films on the first substrate or the second substrate is:
forming a first alignment film on the first substrate, forming a second alignment film on the second substrate;
radiating the first substrate or the second substrate with the alignment films formed obliquely by the polarized ultraviolet light, in order to make the alignment films to form an alignment pre-tilt angle is:
radiating the first substrate with a first alignment film formed obliquely by the polarized ultraviolet light, in order to make the first alignment film to form a first alignment pre-tilt angle, radiating the second substrate with a second alignment film formed obliquely by the polarized ultraviolet light, in order to make the second alignment film to form a second alignment pre-tilt angle;
matching the first substrate and the second substrate as a group and injecting liquid crystal molecules containing reactive monomers in between the first substrate and the second substrate to form a liquid crystal layer, under the influence of the alignment films after group matching, the pre-tilt angle of the liquid crystal molecules being a first angle value is:
matching the first substrate and the second substrate as a group and injecting liquid crystal molecules containing reactive monomers in between the first substrate and the second substrate to form a liquid crystal layer, under the influence of the first alignment film and the second alignment film after group matching, the pre-tilt angle of the liquid crystal molecules being a first angle value.

8. The manufacture method according to claim 4, wherein providing a first substrate and a second substrate is:
providing a thin film transistor array substrate and a color filter plate substrate.

9. A liquid crystal display panel, wherein the liquid crystal display panel comprises a first substrate and a second substrate disposed opposite, a liquid crystal layer containing liquid crystal molecules between the first substrate and the second substrate, at least one layer of alignment film disposed on the first substrate or the second substrate, the liquid crystal molecules comprises reactive monomers, the liquid crystal molecules have a pre-tilt angle, and the pre-tilt angle of the liquid crystal molecules is formed by radiating the alignment films on the first substrate or the second substrate obliquely by a polarized ultraviolet light, a first angle value is formed by matching the first substrate and the second substrate under the influence of the alignment films, subsequently radiating the first substrate or the second substrate vertically by a non-polarized ultraviolet light, and applying electric field between the first substrate and the second substrate to rotate the liquid crystal molecules by radiating the non-polarized ultraviolet light on the reactive monomers, a pre-tilt angle with a second angle value is formed, the second angle value is larger than the first angle value.

10. The liquid crystal display panel according to claim 9, wherein when radiating the alignment films on the first substrate or the second substrate obliquely by a polarized ultraviolet light, a first angle value is formed by matching the first substrate and the second substrate under the influence of the alignment films, a plurality of regions of liquid crystal molecules with different tilting directions are formed in the liquid crystal layer under the influence of the alignment films.

11. The liquid crystal display panel according to claim 9, where in radiating the first substrate or the second substrate vertically by a non-polarized ultraviolet light in a first period of time, and applying electric field between the first substrate and the second substrate to rotate the liquid crystal molecules by radiating the non-polarized ultraviolet light on the reactive monomers, a pre-tilt angle with a second angle value is formed, the second angle value is controlled by various first periods of time.

12. The liquid crystal display panel according to claim 9, wherein a first alignment film is disposed on the first substrate, a second alignment film is disposed on the second substrate, the polarized ultraviolet light radiates obliquely the first substrate and the second substrate respectively and affects the first alignment film and the second alignment film, making the first alignment to form a first alignment pre-tilt angle and the second alignment to form a second alignment pre-tilt angle.

13. The liquid crystal display panel according to claim 9, wherein the reactive monomers are RM materials.
